(19) United States
(12) Patent Application Publication
(10) Pub. No.: US 2019/0297913 A1
(43) Pub. Date: Oct. 3, 2019

(54) PROCESS FOR PRODUCING AN ICE-CREAM BASE

(71) Applicants: Giovanni CRIVELLO, Poirino (TO) (IT); Mario SACCHETTO, Lagnasco (CN) (IT)

(72) Inventors: Giovanni CRIVELLO, Poirino (TO) (IT); Mario SACCHETTO, Lagnasco (CN) (IT)

(21) Appl. No.: 16/317,025

(22) PCT Filed: Jun. 28, 2017
(86) PCT No.: PCT/IT2017/000133

§ 371 Date: Jan. 10, 2019

(30) Foreign Application Priority Data
Jul. 11, 2016 (IT) 102016000072098

(51) Int. Cl. A23G 9/08; A23G 9/40; A23G 9/42

(52) U.S. Cl. CPC A23G 9/08; A23G 9/52; A23G 9/42; A23G 9/40

(57) ABSTRACT

A process is described for producing an ice-cream base, either an ice-cream or fruit sorbet or a cream ice-cream, comprising the steps of: preparing a mixture comprising at least one main ingredient in an amount included between 40% and 85% and complementary ingredients in an amount completing 100%, such complementary ingredients comprising at least one amount of sugar or of one or more sugar syrups; subjecting such mixture to a flash-pasteurization process to obtain a flash-pasteurized ice-cream base. An ice-cream base produced through such process is further described.

### CROSS-REFERENCE TO RELATED APPLICATIONS

The present Application is a national stage of International Patent Application No. PCT/IT2017/000133, titled “Process for Producing an Ice-Cream Base,” filed Jun. 28, 2017, which claims priority from Italian Patent Application No. 102016000072098 filed Jul. 11, 2016, the contents of which are incorporated in this disclosure by reference in their entirety.

### BACKGROUND OF THE INVENTION

### 1) Field of the Invention

The present invention refers to a process for producing an ice-cream base and to an ice-cream base produced through a such process.

### 2) Background Art

As known, the preparation of artisanal ice-cream is mainly based on five major processes: preparing the basic mixture, pasteurizing, maturing, creaming and final firming.

In particular, preparing the base is a major step, since the quality of the deriving ice-cream will consequently depend thereon. Currently, the production of artisanal ice-cream generally provides for the use of pre-packaged bases, within a suitably pre-arranged (and relatively costly) laboratory by making a mixture of the ingredients, both for a creamed for ice-cream based on milk or fruit, its following pasteurization and packaging for transport.

Moreover, above all in case of preparation of bases for fruit-flavored ice-creams, the step of pasteurizing, due to the length of heating times for the mixture to which this latter one must be subjected, generates cooking and “marmalading” of fruit components being present in the mixture itself, with consequent change of taste and organoleptic properties.

### SUMMARY OF THE INVENTION

Therefore, object of the present invention is solving the above prior art problems, by providing a process for producing bases aimed to the final making of ice-creams in different times, avoiding following cooking and/or using the creaming step only.

Moreover, an object of the present invention is providing a process which allows producing bases for ice-cream without impairing the organoleptic qualities of ice-creams and qualitatively improving their taste.

Another object of the present invention is providing a process, which allows producing bases for ice-creams, doing without the use of the classic manufacturing laboratory, with strong decrease of related investments.

Moreover, an object of the present invention is providing a process which allows producing bases for ice-creams free from any type of chemical preservative, though guaranteeing a long storage, employing a not very strong storage in a refrigerator.

Another object of the present invention is providing an ice-cream base aimed to finally making ice-creams in different times, avoiding following cooking and/or using the creaming step only.

Moreover, an object of the present invention is providing an ice-cream base which allows making ice-creams without impairing the organoleptic qualities and qualitatively improving its taste.

The above and other objects and advantages of the invention, as will appear from the following description, are obtained with a process for producing an ice-cream base as claimed in claim 1.

Moreover, the above and other objects and advantages of the invention will be obtained with an ice-cream base as claimed in the present invention.

Preferred embodiments and non-trivial variations of the present invention are the subject matter of the dependent claims.

It is intended that all enclosed claims are an integral part of the present description.

It will be immediately obvious that numerous variations and modifications (for example related to shape, sizes, arrangements and parts with equivalent functionality) can be made to what is described, without departing from the scope of the invention as appears from the enclosed claims.

### DETAILED DESCRIPTION OF PREFERRED EMBODIMENTS

The present invention will be better described by some preferred embodiments thereof, provided as a non-limiting example.

The process according to the present invention for producing an ice-cream base, being it an ice-cream or fruit sorbet or a cream ice-cream, advantageously comprises the steps of:

preparing a mixture comprising at least one main ingredient in an amount included between 40% and 85% and complementary ingredients in an amount completing 100%, where such complementary ingredients comprise at least one amount of sugar or of one or more sugar syrups in varying percentages depending on the taste and the consistency that has to be obtained;

subjecting such mixture to a flash-pasteurization process to obtain a flash-pasteurized ice-cream base.

The step of subjecting the mixture to the flash-pasteurization process, aimed in particular to block the enzymatic charge of the mixture itself, preferably comprises the sub-steps of:

pre-heating the mixture up to a temperature included between 90° C. and 110° C. with following thermal flash of such mixture with heating up to a temperature included between 120° C. and 140° C. for a time included between 3 s and 6 s;

afterwards heating the mixture with flash cooling with a temperature jump included between 35° C. and 55° C. for a time included between 10 s and 25 s.

Moreover, such complementary ingredients can comprise at least one natural thickener chosen, for example, among legume flours, maize amid derivatives, sunflower liposomes.

In particular, if the mixture is used for preparing an ice-cream base or fruit sorbet, at least one main ingredient is advantageously composed of fresh fruits or semi-finished fresh fruits, previously cleaned, peeled, reeled-off and more or less refined (depending on the desired granulometry) and the amount of such main ingredient composed of fresh fruits can be included between 40% and 85% depending on the desired type and consistency.

Moreover, if the mixture is used for preparing an ice-cream base or fruit sorbet, the amount of sugar or of one or more sugar syrups can be included between 10% and 40%.

Moreover, if the mixture is used for preparing an ice-cream base or fruit sorbet, such complementary ingredients can comprise at least one taste and/or acidity exalting agent chosen, for example, between ascorbic acid or citric acid.

Moreover, if the mixture is used for preparing an ice-cream base or fruit sorbet, such complementary ingredients can comprise at least one amount of milk and/or albumen in order to make the mixture more creamy.

In particular, if the mixture is instead used for preparing a cream-based ice-cream, at least one main ingredient is advantageously composed of at least one taste ingredient among the most various ones: for example, such taste ingredient can be chosen among chocolate, coffee, hazelnut, nougat, meringue, etc. The amount of such main ingredient composed of at least one of such taste ingredients can be included between 40% and 60%. Moreover, if the mixture is used for preparing a cream-based ice-cream, such complementary ingredients comprise at least one amount of milk and/or cream included between 40% and 60% and at least one amount of eggs.

The base prepared through the process according to the present invention is therefore 100% of the future ice-cream directly obtained only through its creaming, whether it is traditional, continuous or discontinuous, which will produce the desired creaminess with the desired incorporation of air, consequently allowing to remove the classic and indispensable laboratory for producing the bases, present in every artisanal ice-cream shop.

The process according to the present invention further comprises the step of packaging the flash-pasteurized ice-cream base in at least one storage container.

In particular, such storage container can be preferably composed of any vacuum container, sterile and impermeable to light and gas which, together with the use of the flash-pasteurizing step for the mixture, allows obtaining a storage period of the base obtained according to the process of the present invention which is longer than 12 months.

Preferably, therefore, the storage container can be an aluminized multi-layer bag or container of the “Tetra Pak”® type with various sizes or any visible food container.

As further alternative, the storage container can be composed of a capsule, of a type substantially known in the art, aimed to be used in a delivering device.

In order to get to the end product through the ice-cream base according to the present invention it will also be enough to use the classic machines of the “soft-ice” type, with direct distribution of ice-creams to consumers.

The present invention further deals with an ice-cream base, either an ice-cream or fruit sorbet or a cream ice-cream, produced through a process according to the present invention as previously described, such process comprising at least the steps of:

preparing a mixture comprising at least one main ingredient in an amount included between 40% and 85% and complementary ingredients in an amount completing 100%, where such complementary ingredients comprise at least one amount of sugar or of one or more sugar syrups in a varying percentage depending on the taste and the consistency that has to be obtained;

subjecting such mixture to a flash-pasteurization process to obtain a flash-pasteurized ice-cream base.

Obviously, all other features of the process to obtain the ice-cream base according to the present invention are the previously described ones.

1. A process for producing an ice-cream base or fruit sorbet, the process comprising the steps of:
preparing a mixture comprising at least one main ingredient in an amount included between 40% and 85% and complementary ingredients in an amount completing 100%, the at least one main ingredient being composed of fresh fruits or semi-finished fresh fruits and the amount of the main ingredient composed of fresh fruits being included between 40% and 85%, the complementary ingredients comprising at least one amount of sugar or of one or more sugar syrups; and
subjecting the mixture to a flash-pasteurization process to obtain a flash-pasteurized ice-cream base, the step of subjecting the mixture to the flash-pasteurization process further comprising the steps of:
pre-heating the mixture up to a temperature included between 90° C. and 110° C. with following thermal flash by heating the mixture up to a temperature included between 120° C. and 140° C. for a time included between 3 s and 6 s; and
afterwards heating the mixture with flash cooling with a temperature jump included between 35° C. and 55° C. for a time included between 10 s and 25 s.

2. The process of claim 1, wherein the complementary ingredients comprise at least one natural thickener.

3. The process of claim 1, wherein the amount of sugar or of one or more sugar syrups is included between 10% and 40%.

4. The process of claim 1, wherein the complementary ingredients comprise at least one taste and/or acidity exalting agent.

5. The process of claim 1, wherein the complementary ingredients comprise at least one amount of milk and/or albumen.

6. The process of claim 1, wherein the at least one main ingredient is composed of at least one taste ingredient, an amount of the main ingredient composed of at least one the taste ingredient being included between 40% and 60%.

7. The process of claim 6, wherein the complementary ingredients comprise an amount of milk and/or cream included between 40% and 60% and an amount of eggs.

8. The process of claim 1, further comprising the step of packaging the flash-pasteurized ice-cream base in at least one storage container.

9. The process of claim 8, wherein the storage container is composed of a vacuum container, sterile and impermeable to light and gas.

10. The process of claim 8, wherein the storage container is an aluminized multi-layer bag or container of the “Tetra Pak”® type or a visible or capsule-type food container.

11. (canceled)
